(19) United States
(12) Patent Application Publication
(10) Pub. No.: US 2017/0171713 A1
(43) Pub. Date: Jun. 15, 2017

(54) METHOD AND APPARATUS FOR DETERMINING LOCATION OF TARGET PORTABLE DEVICE

(71) Applicant: Xiaomi Inc., Beijing (CN)

(72) Inventors: Enxing HOU, Beijing (CN); Ziguang GAO, Beijing (CN); Deguo MENG, Beijing (CN)

(73) Assignee: Xiaomi Inc.

(21) Appl. No.: 15/372,764

(22) Filed: Dec. 8, 2016

(30) Foreign Application Priority Data
Dec. 11, 2015 (CN) 201510919464.7

(51) Int. Cl. H04W 4/02; H04W 8/24

(52) U.S. Cl. CPC H04W 4/023; H04W 8/24

(57) ABSTRACT

A method for determining a location of a target portable device is performed by a server and includes: receiving a location searching request corresponding to the target portable device, the location searching request includes a device identification of the target portable device; acquiring, according to the device identification of the target portable device, location information of the target portable device sent by another device when the another device detects a wireless signal of the target portable device; and sending, according to the location information, a location indicating message regarding the target portable device to a first communication terminal linked to the target portable device.

### CROSS-REFERENCE TO RELATED APPLICATIONS

The present application is based upon and claims priority to Chinese Patent Application No. CN201510919464.7 filed Dec. 11, 2015, the entire contents of which are incorporated herein by reference.

### TECHNICAL FIELD

The present disclosure generally relates to the field of computer technology, and more particularly, to a method and an apparatus for determining a location of a target portable device.

### BACKGROUND

With the advancement of electronic devices, they have become more and more popular and the applications in which they can be utilized increase. For example, popular electronic devices include smart wrist bands, smart cards, smart key chains, etc. Such an electronic device is generally provided with a Bluetooth component through which the electronic device can communicate wirelessly with a mobile terminal. A mobile terminal includes a mobile phone or a tablet computer and so on, which is linked to the electronic device, to provide alerts regarding loss of an electronic device.

An electronic device of a user can send a wireless signal to the mobile terminal, such as a mobile phone. The mobile terminal can determine a distance between itself and the electronic device according to strength of the received wireless signal. When the distance between the mobile terminal and the electronic device is larger than a preset threshold distance, the mobile terminal can alert the user through a ringing bell or vibration.

### SUMMARY

According to a first aspect of the present disclosure, there is provided a method for determining a location of a target portable device. The method is performed by a server and comprises: receiving a location searching request corresponding to the target portable device, the location searching request comprising a device identification of the target portable device; acquiring, according to the device identification of the target portable device, location information of the target portable device sent by another device when the another device detects a wireless signal of the target portable device; and sending, according to the location information, a location indicating message regarding the target portable device to a first communication terminal linked to the target portable device.

According to another aspect of the present disclosure, there is provided an apparatus for determining a location of a target portable device. The apparatus includes a processor and a memory for storing instructions executable by the processor. The processor is configured to perform: receiving a location searching request corresponding to the target portable device, the location searching request comprising a device identification of the target portable device; acquiring, according to the device identification of the target portable device, location information of the target portable device sent by another device when the another device detects a wireless signal of the target portable device; and sending, according to the location information, a location indicating message regarding the target portable device to a first communication terminal linked to the target portable device.

According to another aspect of the present disclosure, there is provided a non-transitory computer-readable storage medium storing instructions, which, when executed by a processor in a server, cause the processor to perform a method for determining a location of a target portable device, the method comprising: receiving, by the server, a location searching request corresponding to the target portable device, the location searching request comprising a device identification of the target portable device; acquiring, according to the device identification of the target portable device, location information of the target portable device sent by another device when the another device detects a wireless signal of the target portable device; and sending, according to the location information, a location indicating message regarding the target portable device to a first communication terminal linked to the target portable device.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for determining a location of a target portable device according to an exemplary embodiment.

FIG. 2 illustrates a communication terminal displaying a user interface according to an exemplary embodiment.

FIG. 3 illustrates another communication terminal displaying a user interface according to an exemplary embodiment.

FIG. 4 illustrates another communication terminal displaying a user interface according to an exemplary embodiment.

FIG. 5 is a flow chart illustrating a method for determining a location of a target portable device according to an exemplary embodiment.

FIG. 6 is a block diagram illustrating an apparatus for determining a location of a target portable device according to an exemplary embodiment.

FIG. 7 is a block diagram illustrating a sending module of an apparatus for determining a location of a target portable device according to an exemplary embodiment.

FIG. 8 is a block diagram illustrating an apparatus for determining a location of a target portable device according to an exemplary embodiment.

FIG. 9 is a block diagram illustrating a server for determining a location of a target portable device according to an exemplary embodiment.

Through the above accompanying drawings, the specific embodiments of the present disclosure have been shown, for which a more detailed description will be given below. These drawings and textual description are not intended to limit the scope of the concept of the present disclosure in any manner, but to explain the concept of the present disclosure to those skilled in the art through particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

An exemplary embodiments of the present disclosure provides a method for determining a location of a target portable device, which can be performed by a server, such as a background server for an application program. A user may use various portable devices, such as a smart wrist band, a smart card, a smart key chain, and so on. Such a portable device can be provided with a wireless communication component, for example, a Bluetooth component. The user can link these portable devices to a communication terminal, such as a mobile phone, a tablet computer or other mobile terminals. The communication terminal can be installed with an application program for preventing loss of a portable device. For example, a user registers an account and a password with the application program in the communication terminal and links a portable device to the account in the application program. To this end, the application program can send a linking request to the server, and the server can establish a corresponding relationship between the account and a device identification of the portable device. In some embodiments, the user can also link the portable device to a number of a mobile phone. In this way, the server can store a corresponding relationship between a target portable device and a corresponding communication terminal. The server can include a memory, a processor, and a transceiver. In an embodiment, the memory can be configured to store location information of a target portable device sent by another device when the another device detects a wireless signal of the target portable device, and data required or generated in a processing procedure described below. The processor can be configured to acquire location information of a target portable device sent by another device when the another device detects a wireless signal of the target portable device according to a device identification of the target portable device. The transceiver can be configured to receive a location searching request and send a location indicating message regarding a target portable device to a communication terminal linked with the target portable device. The server can include a power supply and other components.

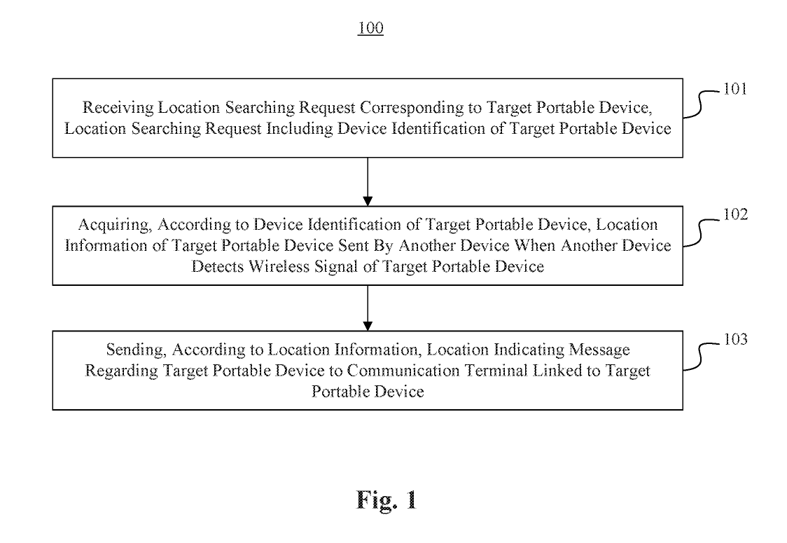

FIG. 1 is a flow chart illustrating a method 100 for determining a location of a target portable device according to an exemplary embodiment. As shown in FIG. 1, the method 100 can be performed by a server and includes the following steps.

In step 101, a location searching request corresponding to a target portable device is received, the location searching request including a device identification of the target portable device.

In an embodiment, when a user finds that a portable device (i.e. the target portable device) is lost, the user can send through a communication terminal a location searching request corresponding to the target portable device to the server. The location searching request can include the device identification of the target portable device. The server can verify the identity of the user, for example, by requiring the user to enter the above mentioned account and a corresponding password, or by requiring the user to enter his or her phone number or other identity information. After the user's identity is verified, the communication terminal can send the location searching request corresponding to the target portable device to the server, and the server can receive the location searching request corresponding to the target portable device.

In step 102, location information of the target portable device sent by another device when the another device detects a wireless signal of the target portable device is acquired according to the device identification of the target portable device.

In an embodiment, the target portable device can periodically send broadcasting messages to surrounding devices through a wireless communication component. The broadcasting messages can include the device identification of the target portable device. For example, the broadcasting messages can be messages sent through a Bluetooth component, and the device identification of the target portable device can be a Media Access Control (MAC) address. Each surrounding device (i.e. the another device) can receive the broadcasting message sent by the target portable device, and then can acquire location information of the surrounding device itself. If the surrounding device is equipped with a Global Positioning System (GPS) component, the location information can be positioning information acquired through the GPS component when the surrounding device detects the wireless signal of the target portable device. If the surrounding device is not equipped with a GPS component, the location information can be the device identification of the surrounding device. Each surrounding device can parse the broadcasting message received to acquire the device identification of the target portable device in the broadcasting message, and send the device identification of the target portable device and the location information to the server.

The server can receive the device identification and corresponding location information sent by each of the one or more devices, and store the device identification and the location information received from each device as corresponding to each other to establish a corresponding relationship between the device identification and the location information. Upon receipt of the location searching request corresponding to the target portable device, the server can parse the location searching request to acquire the device identification of the target portable device therein. The server can acquire the location information corresponding to the device identification of the target portable device in the above mentioned corresponding relationship.

In some embodiments, another device can send time information to the server. In this case, in step 102, the server may acquire location information of the target portable device and time information sent by another device when the another device detects a wireless signal of the target portable device.

In an embodiment, the another device can be equipped with a clock component. Upon receipt of a broadcasting message sent by the target portable device, the another device can acquire its own location information and time information of the current time. The another device can parse the broadcasting message received to acquire the device identification of the target portable device from the broadcasting message, and can send the device identification of the target portable device, the location information, and the time information to the server.

The server can receive the device identification and corresponding location information and corresponding timing information sent by one or more devices, and store the device identification, the location information, and the time information received from each device as corresponding to one another to establish a corresponding relationship among the device identification, the location information, and the time information. Upon receipt of the location searching request corresponding to the target portable device, the server can parse the location searching request to acquire the device identification of the target portable device therein. The server can acquire the location information and the time information corresponding to the device identification of the target portable device in the above mentioned corresponding relationship.

In some embodiments, the server can store pieces of location information and time information corresponding to the identification of the target portable device received in a relatively long period of time. In order to improve the efficiency of acquiring information for the user, the server can acquire part of the pieces of location information and time information from the stored pieces of location information and time information. The corresponding procedure can be one of the following two manners.

In a first manner, according to the device identification of the target portable device, the server acquires a piece of location information which corresponds to a piece of time information closest to the current time from the received pieces of location information of the target portable device, and the pieces of time information corresponding to the pieces of location information.

In an embodiment, the server can determine the current time and a first piece of time information which is closest to the current time from the stored corresponding relationship among the device identification, location information, and time information. The server acquires a piece of location information corresponding to the first piece of time information. For example, the current time is 10:00. The server stores the following information. At 8:00, the location information corresponding to the device identification is Location a. At 9:00, the location information corresponding to the device identification is Location b. At 9:50, the location information corresponding to the device identification is Location c. The server can acquire the Location c and the corresponding time information 9:50, which is closest to the current time, 10:00.

In a second manner, according to the device identification of the target portable device, the server acquires a piece of location information which corresponds to a piece of time information earlier than the current time by a time difference within a preset threshold, from the received pieces of location information of the target portable device, and the pieces of time information corresponding to the pieces of location information.

In an embodiment, the server can determine the current time and a second piece of time information which is closest to the current time from the stored corresponding relationship among the device identification, location information, and time information. The server acquires a piece of location information corresponding to the second piece of time information. For example, the current time is 10:00. The server stores the following information. At 8:00, the location information corresponding to the device identification is Location a. At 9:00, the location information corresponding to the device identification is Location b. At 9:50, the location information corresponding to the device identification is Location c. When the preset threshold is 90 minute, the server can acquire both Location b and its corresponding time information 9:00, and the Location c and its corresponding time information 9:50.

In step 103, according to the location information, a location indicating message regarding the target portable device is sent to a communication terminal linked to the target portable device.

In an embodiment, according to the stored linking relationship between the target portable device and the corresponding communication terminal, the server can determine a communication terminal (referred to as a first communication terminal) corresponding to the device identification of the target portable device. Upon acquiring the location information of the target portable device, the server can send a location indicating message regarding the target portable device to the first communication terminal according to the location information.

In some embodiments, in step 103, a location indicating message including the time information and location information regarding the target portable device is sent to a communication terminal linked to the target portable device.

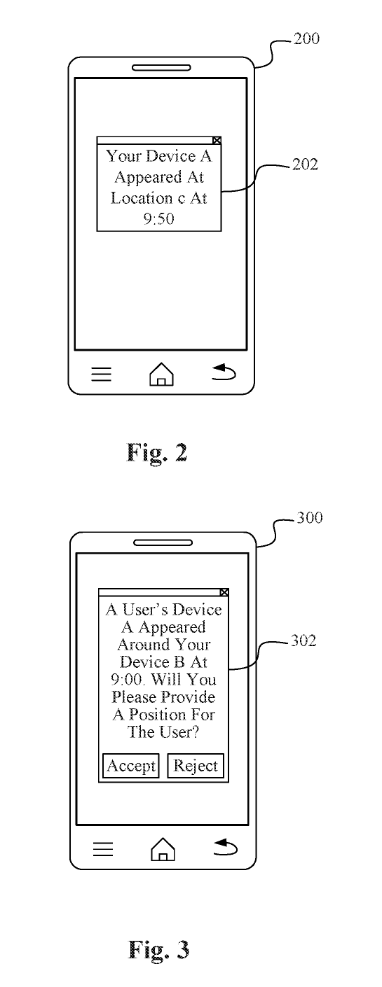

In an embodiment, upon acquiring the location information of the target portable device sent from another device, according to the stored linking relationship between the target portable device and the corresponding communication terminal, the server can determine a first communication terminal corresponding to the device identification of the target portable device. The server can send a location indicating message which includes the positioning information and the time information corresponding to the target portable device to the first communication terminal. The first communication terminal can receive the location indicating message sent from the server and display the location indicating message. For example, a first communication terminal 200 can display a location indicating message 202: “Your device A appeared at Location c at 9:50”, as shown in FIG. 2.

In some embodiments, in a case in which another device is equipped with a GPS component, the location information can include positioning information acquired by the GPS component when the another device detects the wireless signal of the target portable device. Correspondingly, in step 103, a location indicating message regarding the target portable device sent to a communication terminal linked to the target portable device can include the positioning information.

In an embodiment, upon acquiring the positioning information of the target portable device sent from the another device, the server can determine a first communication terminal corresponding to the device identification of the target portable device according to the stored linking relationship between the target portable device and the corresponding communication terminal. The server can send a location indicating message including the positioning information to the first communication terminal. In addition, the location indicating message can also include time information corresponding to the positioning information. The first communication terminal can receive the location indicating message sent from the server and display the location indicating message. For example, the first communication terminal can display a location indicating message: “Your device A appeared at Location c at 9:50”.

In some embodiments, in a case in which the another device is not equipped with a GPS component, the location information can be a device identification of the another device. Correspondingly, in step 103, the server acquires an account identification corresponding to the device identification of the another device and sends a location indicating message regarding the target portable device to a communication terminal linked to the target portable device. The location indicating message includes the account identification.

In an embodiment, upon acquiring the device identification of the another device, the server can determine an account identification corresponding to the device identification. The account identification can be an account identification of an account linked to the another device. The server can determine a first communication terminal corresponding to the device identification of the target portable device according to the stored linking relationship between the target portable device and the corresponding communication terminal. The server can send a location indicating message to the first communication terminal, and the location indicating message can include the account identification corresponding to the device identification of the another device and the device identification of the another device. The first communication terminal can receive and display the location indicating message sent from the server. For example, the first communication terminal can display “Your device A appears around device B of Zhang San.” After the user sees the location indicating message, the user can add the account corresponding to the account identification as a friend, such that the user can communicate with the user of the account, for example, by sending chat messages or using voice communication, and so on. In this way, the first user desiring to find his/her target portable device can seek assistance from a user of the account to acquire relevant information about the target portable device for the first user to find the target portable device.

In some embodiments, the corresponding account identification is sent to the communication terminal linked to the target portable device after the user of the another device approves it. Correspondingly, in step 103, an account identification corresponding to a device identification of the another device is acquired, an assistance request is sent to a communication terminal currently logged in the account corresponding to the account identification; if it is received a confirmation message sent from the communication terminal linked to the account corresponding to the received account identification, a location indicating message regarding the target portable device is sent to a communication terminal linked to the target portable device, the location indicating message including the account identification.

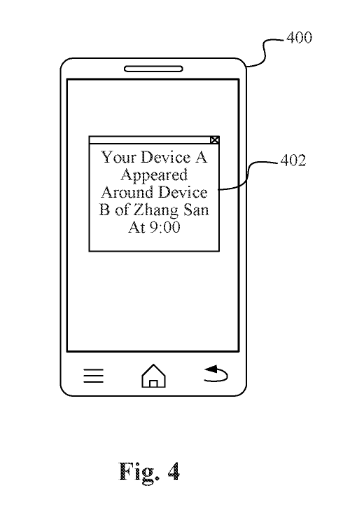

In an embodiment, upon acquiring the device identification of the another device, the server can determine the account identification corresponding to the device identification. The account identification can be an account identification of an account linked to the another device. The server can send an assistance request to a communication terminal (referred to as a second communication terminal) currently logged into the account, the assistance request including the device identification of the target portable device and the device identification of the another device. In addition, in a case in which the another device sends out time information, the assistance request can also include time information. The second communication terminal can receive and display the assistance request sent from the server. For example, as shown in FIG. 3, a second communication terminal 300 can display an assistance request 302: “A User's Device A appeared around your device B at 9:00. Will you please provide a position for the user?” The second communication terminal 300 can accept or reject the option. If the second communication terminal 300 receives a click instruction corresponding to the “Accept” option, it can send a confirmation message to the server. After the server receives the confirmation message, the server can send a location indicating message to the first communication terminal. The location indicating message can include the device identification of the another device and the corresponding account identification and time information. The first communication terminal can receive and display the location indicating message sent from the server. For example, as shown in FIG. 4, a first communication terminal 400 can display a location indicating message 402: “Your device A appeared around device B of Zhang San at 9:00”. After seeing the location indicating message, the user of the first communication terminal 400 can add the account corresponding to the account identification as a friend, such that the user of the first communication terminal 400 can communicate with the user of the account, for example, by sending chat messages or using voice communication, and so on. In this way, the user desiring to find his/her target portable device can seek assistance from the user of the account to acquire relevant information about the target portable device for the user to find the target portable device.

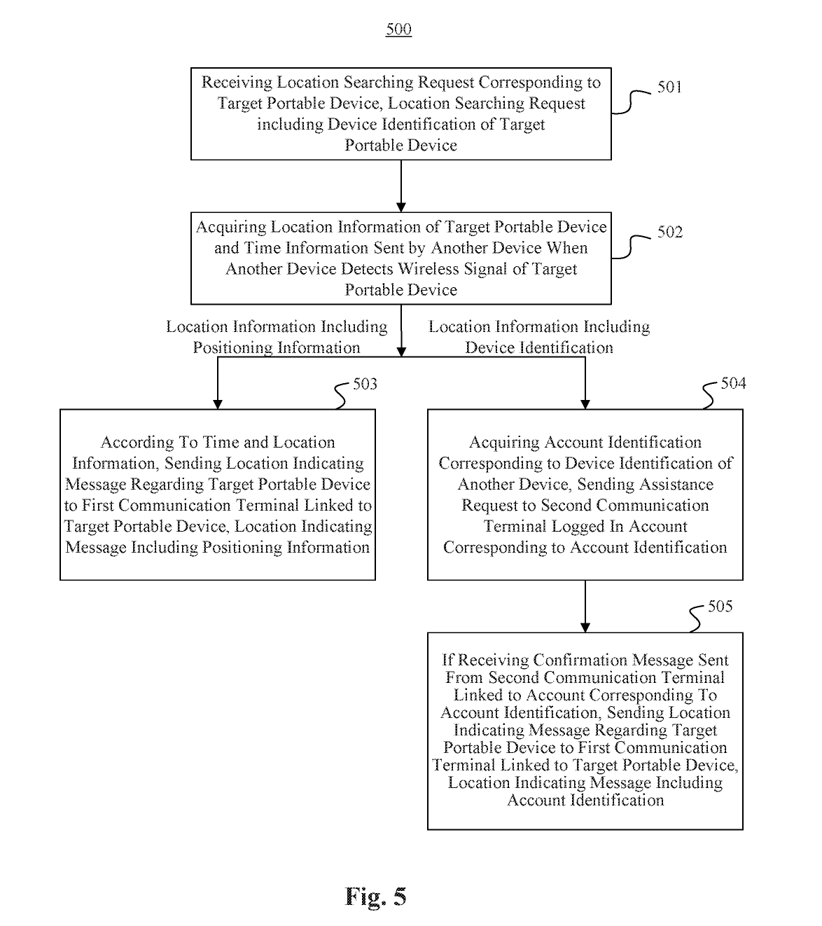

The present disclosure further provides a method 500 for determining a location of a target portable device. The method 500 may be performed by a server. As shown in FIG. 5, the method 500 can include the following steps.

In step 501, a location searching request corresponding to a target portable device is received, the location searching request including a device identification of the target portable device.

In an embodiment, when a user finds that a portable device (i.e. the target portable device) is lost, the user can send through a communication terminal a location searching request corresponding to the target portable device to the server. The location searching request can include the device identification of the target portable device. The server can receive the location searching request. The server can verify the identity of the user, for example, by requiring the user to enter the above-mentioned account and a corresponding password, or by requiring the user to enter his or her phone number or other identity information. After the user's identity is verified, the communication terminal can send the location searching request corresponding to the target portable device to the server.

In step 502, location information of the target portable device and time information sent by another device when the another device detects a wireless signal of the target portable device are acquired.

In an embodiment, the another device can be equipped with a clock component. Upon receipt of a broadcasting message sent by the target portable device, the another device can acquire its own location information and time information of the current time. If the another device is equipped with a GPS component, the location information can include positioning information acquired by the GPS component when the another device detects a wireless signal of the target portable device. If the another device is not equipped with a GPS component, the location information can be a device identification of the another device. The another device can parse the broadcasting message to acquire the device identification of the target portable device, and send the device identification of the target portable device, the location information and the time information to the server.

The server can receive the device identification and corresponding location information and timing information sent by one or more devices, and store the device identification, the location information, and the time information received from each device as corresponding to one another to establish a corresponding relationship among the device identification, the location information, and the time information. Upon receipt of the location searching request corresponding to the target portable device, the server can parse the location searching request to acquire the device identification of the target portable device therein. The server can acquire the location information and the time information corresponding to the device identification of the target portable device in the above-mentioned corresponding relationship. If the location information includes positioning information, step 503 is performed; and if the location information is a device identification, step 504 is performed.

In step 503, according to the time information and the location information, a location indicating message regarding the target portable device is sent to a first communication terminal linked to the target portable device, the location indicating message including the positioning information.

In an embodiment, upon acquiring the positioning information of the target portable device sent from the another device, the server can determine a first communication terminal corresponding to the device identification of the target portable device according to the stored linking relationship between the target portable device and the corresponding communication terminal. The server then sends a location indicating message to the first communication terminal. The location indicating message can include the positioning information and corresponding time information. The first communication terminal can receive and display the location indicating message sent from the server.

In step 504, an account identification corresponding to a device identification of the another device is acquired, and an assistance request is sent to a second communication terminal currently logged into the account corresponding to the account identification.

In an embodiment, upon acquiring the device identification of the another device, the server can determine an account identification corresponding to the device identification. The account identification can be an account identification of an account linked to the another device. The server can send an assistance request to a communication terminal (referred to as a second communication terminal) currently logged into the account, the assistance request including the device identification of the target portable device and the device identification of the another device. In some embodiments, in a case in which the another device provides time information, the assistance request can also include the time information.

In step 505, if the server receives a confirmation message sent from the second communication terminal linked to the account corresponding to the received account identification, the server sends a location indicating message regarding the target portable device to a first communication terminal linked to the target portable device, the location indicating message including the account identification.

In an embodiment, the second communication terminal can receive and display the assistance request sent from the server. After the second communication terminal receives a click instruction corresponding to an “Accept” option indicating a second user of the second communication terminal agrees to assist, a confirmation message can be sent to the server. After the server receives the confirmation message, the server can send a location indicating message to the first communication terminal. The location indicating message can include the device identification of the another device and the corresponding account identification. The first communication terminal can receive and display the location indicating message sent from the server.

In the embodiments of the present disclosure, a server can receive a location searching request corresponding to a target portable device, the location searching request including a device identification of the target portable device. The server can further acquire location information of the target portable device sent by another device when the another device detects a wireless signal of the target portable device according to the device identification of the target portable device. According to the location information, the server sends a location indicating message regarding the target portable device to a communication terminal linked to the target portable device. In this way, when the user finds that he or she lost an electronic device, the location information about the electronic device can be provided for the user to find the electronic device.

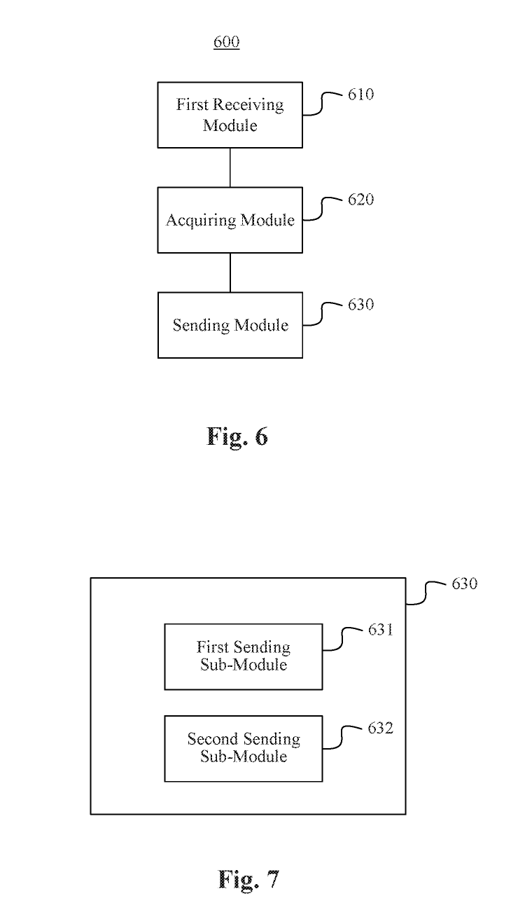

Another exemplary embodiment of the present disclosure provides an apparatus 600 for determining a location of a target portable device. As shown in FIG. 6, the apparatus 600 includes: a first receiving module 610, an acquiring module 620, and a sending module 630.

The first receiving module 610 is configured to receive a location searching request corresponding to a target portable device, the location searching request including a device identification of the target portable device.

The acquiring module 620 is configured to acquire, according to the device identification of the target portable device, location information of the target portable device sent by another device when the another device detects a wireless signal of the target portable device.

The sending module 630 is configured to send, according to the location information, a location indicating message regarding the target portable device to a communication terminal linked to the target portable device.

In some embodiments, the location information includes positioning information of the another device acquired when the another device detects a wireless signal of the target portable device, such that the sending module 630 is configured to send a location indicating message regarding the target portable device to a communication terminal linked to the target portable device, the location indicating message including the positioning information.

In some embodiments, the location information is a device identification of the another device, such that the sending module 630 is configured to acquire an account identification corresponding to the device identification of the another device, and send a location indicating message regarding the target portable device to a communication terminal linked to the target portable device, the location indicating message including the account identification.

In some embodiments, as shown in FIG. 7, the sending module 630 includes a first sending sub-module 631 and a second sending sub-module 632.

The first sending sub-module 631 is configured to acquire an account identification corresponding to the device identification of the another device, and send an assistance request to a second communication terminal which is logged in by an account corresponding to the account identification.

The second sending sub-module 632 is configured to, if the server receives a confirmation message sent from the second communication terminal linked to the account corresponding to the account identification, send a location indicating message regarding the target portable device to a first communication terminal linked to the target portable device, the location indicating message including the account identification.

In some embodiments, the acquiring module 620 is configured to:

acquire location information of the target portable device and time information sent by the another device when the another device detects a wireless signal of the target portable device; and

the sending module 630 is configured to:

send, according to the location information and the time information, a location indicating message regarding the target portable device to a communication terminal linked to the target portable device.

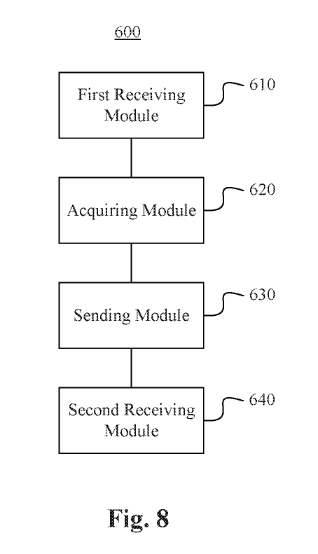

In some embodiments, as shown in FIG. 8, the apparatus 600 further includes:

a second receiving module 640 configured to receive the location information of the target portable device and the time information sent by the another device when the another device detects a wireless signal of the target portable device.

The acquiring module 620 is configured to:

according to the device identification of the target portable device, acquire a piece of location information which corresponds to a piece of time information closest to the current time from the received pieces of location information of the target portable device, and acquire the piece of time information corresponding to the piece of location information; or

according to the device identification of the target portable device, acquire a piece of location information which corresponds to a piece of time information earlier than the current time by a time difference within a preset threshold, from the received pieces of location information of the target portable device, and acquire the piece of time information corresponding to the piece of location information.

With respect to the devices in the above embodiments, the specific manners for performing operations for individual modules therein have been described in detail in the embodiments regarding the methods, which will not be elaborated herein.

In the embodiments of the present disclosure, a server, such as the apparatus 600, can receive a location searching request corresponding to a target portable device, the location searching request including a device identification of the target portable device. The server can further acquire location information of the target portable device sent by another device when the another device detects a wireless signal of the target portable device according to the device identification of the target portable device. According to the location information, the server sends a location indicating message regarding the target portable device to a communication terminal linked to the target portable device. In this way, when the user finds that he or she lost an electronic device, the location information about the electronic device can be provided for the user to find the electronic device.

It should be noted that, the modules of the apparatus 600 for determining a location of a target portable device are only illustrated. In some embodiments, the above functions may be assigned to different functional modules as desired. That is, the internal structure of the mobile terminal may be divided into different functional modules to accomplish all or a part of the functions described above. Further, the above embodiments of an apparatus for determining a location of a target portable device and the embodiments of a method for determining a location of a target portable device belong to the same invention conceptive, and the specific processes performed by the apparatus may refer to the embodiments of the method. Therefore, the description thereof will not be repeated herein.

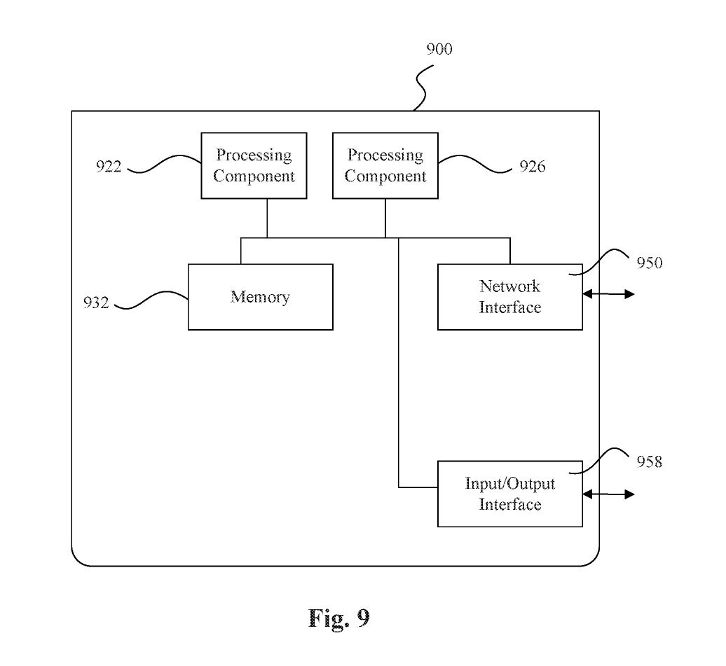

Another exemplary embodiment of the present disclosure provides an apparatus 900 for determining a location of a target portable device. For example, the apparatus 900 may be provided as a server. Referring to FIG. 9, the apparatus 900 includes a processing component 922 that further includes one or more processors, and memory resources represented by a memory 932 for storing instructions, such as application programs, executable by the processing component 922. The application programs stored in the memory 932 may include one or more modules each corresponding to a set of instructions. Further, the processing component 922 is configured to execute the instructions to perform the above described method for determining a location of a target portable device.

The apparatus 900 also includes a power component 926 configured to perform power management of the apparatus 900, a wired or wireless network interface(s) 950 configured to connect the apparatus 900 to a network, and an input/output (I/O) interface 958. The apparatus 900 may operate based on an operating system stored in the memory 932, such as Windows Server™, Mac OS X™, Unix™, Linux™, FreeBSD™, or the like.

The apparatus 900 includes the memory 932 and one or more programs stored in the memory 932 and configured to be executable by the one or more processors of the processing component 922. The one or more programs include instructions to perform the above-described methods for determining a location of a target portable device.

The present disclosure also provides a non-transitory computer readable storage medium storing instructions which, when executed by a processor of a server, cause the server to perform the above-described methods for determining a location of a target portable device.

Other embodiments of the invention will be apparent to those skilled in the art from consideration of the specification and practice of the embodiments disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for determining a location of a target portable device, the method being performed by a server and comprising:
receiving a location searching request corresponding to the target portable device, the location searching request comprising a device identification of the target portable device;
acquiring, according to the device identification of the target portable device, location information of the target portable device sent by another device when the another device detects a wireless signal of the target portable device; and
sending, according to the location information, a location indicating message regarding the target portable device to a first communication terminal linked to the target portable device.

2. The method of claim 1, wherein:
the location information comprises positioning information of the another device acquired when the another device detects the wireless signal of the target portable device; and
the location indicating message comprises the positioning information.

3. The method of claim 1, wherein:
the location information comprises a device identification of the another device; and
the sending, according to the location information, a location indicating message regarding the target portable device to the first communication terminal linked to the target portable device comprises:
acquiring an account identification corresponding to the device identification of the another device, and sending a location indicating message regarding the target portable device to the first communication terminal linked to the target portable device, the location indicating message comprising the account identification.

4. The method of claim 3, further comprising:
after acquiring the account identification corresponding to the device identification of the another device, sending an assistance request to a second communication terminal which is logged in by an account corresponding to the account identification; and
if the server receives a confirmation message indicating an agreement to assist sent from the second communication terminal linked to the account corresponding to the account identification, sending a location indicating message regarding the target portable device to the first communication terminal linked to the target portable device, the location indicating message comprising the account identification.

5. The method of claim 1, further comprising:
acquiring time information sent by the another device when the another device detects the wireless signal of the target portable device, wherein the location indicating message regarding the target portable device sent to the first communication terminal comprises the time information.

6. The method of claim 2, further comprising:
acquiring time information sent by the another device when the another device detects the wireless signal of the target portable device, wherein the location indicating message regarding the target portable device sent to the first communication terminal comprises the time information.

7. The method of claim 3, further comprising:
acquiring time information sent by the another device when the another device detects the wireless signal of the target portable device, wherein the location indicating message regarding the target portable device sent to the first communication terminal comprises the time information.

8. The method of claim 4, further comprising:
acquiring time information sent by the another device when the another device detects the wireless signal of the target portable device, wherein the location indicating message regarding the target portable device sent to the first communication terminal comprises the time information.

9. The method of claim 5, further comprising:
receiving pieces of location information of the target portable device and time information sent by one or more detecting devices when the detecting devices detect a wireless signal of the target portable device; and
according to the device identification of the target portable device, acquiring a piece of location information which corresponds to a piece of time information closest to a current time, from the received pieces of location information of the target portable device, and acquiring the piece of time information corresponding to the piece of location information; or
according to the device identification of the target portable device, acquiring a piece of location information which corresponds to a piece of time information earlier than a current time by a time difference within a preset threshold, from the received pieces of location information of the target portable device, and acquiring the piece of time information corresponding to the piece of location information.

10. An apparatus for determining a location of a target portable device, comprising:
a processor; and
a memory for storing instructions executable by the processor,
wherein the processor is configured to perform:
receiving a location searching request corresponding to the target portable device, the location searching request comprising a device identification of the target portable device;
acquiring, according to the device identification of the target portable device, location information of the target portable device sent by another device when the another device detects a wireless signal of the target portable device; and
sending, according to the location information, a location indicating message regarding the target portable device to a first communication terminal linked to the target portable device.

11. The apparatus of claim 10, wherein
the location information comprises positioning information of the another device acquired when the another device detects the wireless signal of the target portable device; and
the processor is further configured to perform:
sending a location indicating message regarding the target portable device to the first communication terminal linked to the target portable device, the location indicating message comprising the positioning information.

12. The apparatus of claim 10, wherein
the location information comprises a device identification of the another device; and
the processor is further configured to perform:
acquiring an account identification corresponding to the device identification of the another device, and sending a location indicating message regarding the target portable device to the first communication terminal linked to the target portable device, the location indicating message comprising the account identification.

13. The apparatus of claim 12, wherein the processor is further configured to perform:
after acquiring the account identification corresponding to the device identification of the another device, sending an assistance request to a second communication terminal which is logged in by an account corresponding to the account identification; and
if the server receives a confirmation message indicating an agreement to assist sent from the second communication terminal linked to the account corresponding to the account identification, sending a location indicating message regarding the target portable device to the first communication terminal linked to the target portable device, the location indicating message comprising the account identification.

14. The apparatus of claim 10, wherein the processor is further configured to perform:
acquiring time information sent by the another device when the another device detects the wireless signal of the target portable device, wherein the location indicating message regarding the target portable device sent to the first communication terminal comprises the time information.

15. The apparatus of claim 11, wherein the processor is further configured to perform:
acquiring time information sent by the another device when the another device detects the wireless signal of the target portable device, wherein the location indicating message regarding the target portable device sent to the first communication terminal comprises the time information.

16. The apparatus of claim 12, wherein the processor is further configured to perform:
acquiring time information sent by the another device when the another device detects the wireless signal of the target portable device, wherein the location indicating message regarding the target portable device sent to the first communication terminal comprises the time information.

17. The apparatus of claim 13, wherein the processor is further configured to perform:
acquiring time information sent by the another device when the another device detects the wireless signal of the target portable device, wherein the location indicating message regarding the target portable device sent to the first communication terminal comprises the time information.

18. The apparatus of claim 14, wherein the processor is further configured to perform:
receiving pieces of location information of the target portable device and time information sent by one or more detecting devices when the detecting devices detect a wireless signal of the target portable device; and
according to the device identification of the target portable device, acquiring a piece of location information which corresponds to a piece of time information closest to a current time, from the received pieces of location information of the target portable device, and acquiring the piece of time information corresponding to the piece of location information; or
according to the device identification of the target portable device, acquiring a piece of location information which corresponds to a piece of time information earlier than a current time by a time difference within a preset threshold, from the received pieces of location information of the target portable device, and acquiring the piece of time information corresponding to the piece of location information.

19. A non-transitory computer-readable storage medium storing instructions, which, when executed by a processor in a server, cause the processor to perform a method for determining a location of a target portable device, the method comprising:
receiving a location searching request corresponding to the target portable device, the location searching request comprising a device identification of the target portable device;
acquiring, according to the device identification of the target portable device, location information of the target portable device sent by another device when the another device detects a wireless signal of the target portable device; and
sending, according to the location information, a location indicating message regarding the target portable device to a first communication terminal linked to the target portable device.

20. The non-transitory computer-readable storage medium of claim 19, wherein
the location information is positioning information of the another device acquired when the another device detects a wireless signal of the target portable device; and
the sending, according to the location information, a location indicating message regarding the target portable device to the first communication terminal linked to the target portable device comprises:
sending a location indicating message regarding the target portable device to the first communication terminal linked to the target portable device, the location indicating message comprising the positioning information.
